(19) United States
(12) Patent Application Publication
(10) Pub. No.: US 2024/0412217 A1
(43) Pub. Date: Dec. 12, 2024

(54) A COMMUNICATIONS SERVER, A METHOD, A USER DEVICE, AN E-COMMERCE SERVER AND A SYSTEM

(71) Applicant: GRABTAXI HOLDINGS PTE. LTD., Singapore (SG)

(72) Inventors: Haijin FAN, Singapore (SG); Hendra Teja WIRAWAN, Singapore (SG); Ashish Ranjan KARN, Singapore (SG)

(21) Appl. No.: 18/699,725

(22) PCT Filed: Sep. 16, 2022
(86) PCT No.: PCT/SG2022/050664

§ 371 Date: Apr. 9, 2024

(30) Foreign Application Priority Data
Nov. 16, 2021 (SG) 10202112748S

(51) Int. Cl. G06Q 20/40; G06Q 10/083

(52) U.S. Cl. CPC G06Q 20/4015; G06Q 10/0838

(57) ABSTRACT

A communications server apparatus 102 comprising a microprocessor 116 and a memory 118, the communications server apparatus 102 being configured, under control of the microprocessor 116, to execute instructions 120 stored in the memory 118, to: determine an estimated time of arrival (ETA) for the delivery trip, determine a level of confidence for the ETA, determine a delivery time threshold based on a delivery distance for the delivery trip, determine a customer sensitivity factor based on historical transaction data for a user related to the delivery trip, and determine an ETA buffer time based on the level of confidence, the delivery time threshold and/or the customer sensitivity factor. Also, a method, a user device, an e-commerce server and system.

### TECHNICAL FIELD

The invention relates generally to the field of communications. One aspect of the invention relates to a communications server apparatus for Estimated Time of Arrival (ETA) estimation. Another aspect of the invention relates to a method, performed in a communications server apparatus for ETA estimation. Another aspect of the invention relates to a communications device for ETA estimation. Another aspect of the invention relates to an e-commerce server. Another aspect of the invention relates to a method of ETA estimation.

One aspect has particular, but not exclusive, application in food or logistics delivery. For example, where it may be necessary to batch deliveries to optimise ETAs of a large number of simultaneous deliveries.

### BACKGROUND

Various forms of ETA estimation exist.

For example, in U.S. Pat. No. 10,911,903, a method of estimating ETA is disclosed. Prior approaches generally do not determine or factor in the specific user's sensitivity to inaccurate ETA estimation. U.S. Pat. Nos. 10,321,263 and 9,076,330 also disclose methods of ETA estimation.

### SUMMARY

Embodiments may be implemented as set out in the independent claims. Some optional features are defined in the dependent claims.

In at least some implementations, the techniques disclosed herein may allow for:
The technical solution of optimised matching of customers to drivers (using optimised wait time buffer) for the technical problem of reducing greenhouse emissions from driver vehicles.
the technical solution of optimised solving models for the technical problem of optimising an estimated ETA buffer;
the technical solution of determining a confidence score of an estimated ETA for the technical problem of improving transaction viability;
the technical solution of identifying customers who prefer green delivery based on the technical problem of maximising driver vehicle efficiency and/or minimising environmental impact;
the technical solution of reducing the data traffic transmitted between multiple platforms/vendors servers and a given user device, or between applications or modules within a server, based on the technical problem of user choice between multiple platforms/vendors having the same ETA estimate and the same perception about ETA accuracy from past experience (in other words offering a better choice will reduce the amount of checking different vendors); and/or
the technical solution of reduced data centre energy requirements for multiple platforms/vendors based on the technical problem of user choice between multiple platforms/vendors having the same ETA estimate and the same perception about ETA accuracy from past experience (in other words offering a better choice will reduce the amount of checking different vendors).

In an exemplary implementation, the functionality of the techniques disclosed herein may be implemented in software running on a server communications apparatus, such as a cloud based database. The software which implements the functionality of the techniques disclosed herein may be contained in a computer program, or computer program product-which operates the database instances on each server node in the cloud. When running on, for example, a cloud server, the hardware features of the server may be used to implement the functionality described below, such as using the server network communications interface components to establish the secure communications channel for estimated an ETA buffer based on at least customer sensitivity to long delivery times.

### BRIEF DESCRIPTION OF THE DRAWINGS

The invention will now be described, by way of example only, and with reference to the accompanying drawings in which:

FIG. 1 is a schematic block diagram illustrating an exemplary ride hailing service.

FIG. 2 is a schematic block diagram illustrating an exemplary communications server apparatus for routing PSPs related to a transportation service.

FIG. 3 is a schematic diagram of an ETA prediction system and an ETA padding system.

FIG. 4 is a block diagram of an Optimisation Engine for ETA padding.

FIG. 5 is a graph of a Normal distribution of ETA.

FIG. 6 is a graph of trips with non-perfect ratings where the customer feedback included that the delivery took too long.

FIG. 7 is a graph of the derivatives of the plots in FIG. 6.

FIG. 8 is a graph of the percentage change in derivative of the plots in FIG. 7.

### DETAILED DESCRIPTION

The techniques described herein are described primarily with reference to use in taxi, ride hailing, ride sharing, food delivery, online groceries, service/trade exchanges, and pet transport, but it will be appreciated that these techniques have a broader reach and can be usefully implemented in other fields like logistics, or delivery service, or any operation which requires any form of timing estimation for customers to decide whether to proceed with the transaction. Generally, this might be the case in any e-commerce site with delivery.

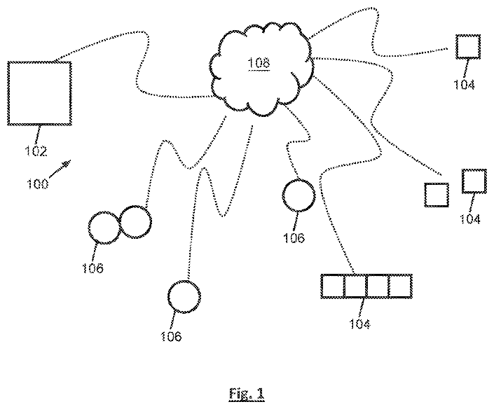

FIG. 1 shows a ride hailing system 100, with a number of users each having a communications device 104, a number of drivers each having a user interface communications device 106, a server 102 (or geographically distributed servers) and communication links 108 connecting each of the components. Each user contacts the server 102 using an app on the communications device 104. The user app may allow the user to enter their pick-up location, a destination address, a level of service and/or after ride information such as a rating. The level of service may include the number of seats of the vehicle, the style of vehicle, level of environmental impact and/or what kind of transport service. It may be also used to order food or other deliveries. Each driver contacts the server 102 using an app on the communications device 106. The driver app allows the driver to indicate their availability to take jobs, information about their vehicle, their location and/or after ride info such as a rating. The server 102 may then match users to drivers, based on: geographic location of users and drivers, maximising revenue, user or driver feedback ratings, weather, driving conditions, traffic levels/accidents, relative demand, environmental impact, and/or supply levels. This allows an efficient allocation of resources because the available fleet of drivers is optimised for the users' demand in each geographic zone.

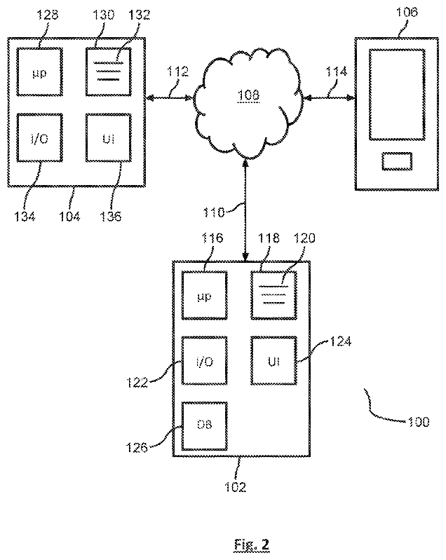

Referring to FIG. 2, a communications apparatus 100 is illustrated which may be used to implement the system of FIG. 1. The communications apparatus 100 comprises the communications server 102, and it may include the user communications device 104 and the driver communications device 106. These devices are connected in the communications network 108 (for example, the Internet) through respective communications links 110, 112, 114 implementing, for example, internet communications protocols. The communications devices 104, 106 may be able to communicate through other communications networks, including mobile cellular communications networks, private data networks, fiber optic connections, laser communication, microwave communication, satellite communication, etc., but these are omitted from FIG. 2 for the sake of clarity.

The communications server apparatus 102 may be a single server as illustrated schematically in FIG. 2, or have the functionality performed by the server apparatus 102 distributed across multiple server components. In the example shown in FIG. 2, the communications server apparatus 102 may comprise a number of individual components including, but not limited to, one or more microprocessors 116, a memory 118 (e.g. a volatile memory such as a RAM, and/or longer term storage such as SSD (Solid State or Hard disk drives (HDD)) for the loading of executable instructions 120, the executable instructions defining the functionality the server apparatus 102 carries out under control of the microprocessor 116. The communications server apparatus 102 also comprises an input/output module 122 allowing the server to communicate over the communications network 108. User interface 124 is provided for user control and may comprise, for example, computing peripheral devices such as display monitors, computer keyboards and the like. The server apparatus 102 also comprises a database 126, the purpose of which will become readily apparent from the following discussion.

The user communications device 104 may comprise a number of individual components including, but not limited to, one or more microprocessors 128, a memory 130 (e.g. a volatile memory such as a RAM) for the loading of executable instructions 132, the executable instructions defining the functionality the user communications device 104 carries out under control of the microprocessor 128. The user communications device 104 also comprises an input/output module 134 allowing the user communications device 104 to communicate over the communications network 108. A user interface 136 is provided for user control. If the user communications device 104 is, say, a smart phone or tablet device, the user interface 136 will have a touch panel display as is prevalent in many smart phone and other handheld devices. Alternatively, if the user communications device is, say, a desktop or laptop computer, the user interface 136 may have, for example, computing peripheral devices such as display monitors, computer keyboards and the like.

The driver communications device 106 may be, for example, a smart phone or tablet device with the same or a similar hardware architecture to that of the user communications device 104. Alternatively, the functionality may be integrated into a bespoke device such as a taxi fleet management terminal.

Thus, it will be appreciated that FIGS. 2 and 3 and the foregoing description illustrate and describe a communications server apparatus 102 comprising a microprocessor 116 and a memory 118, the communications server apparatus 102 being configured, under control of the microprocessor 116, to execute instructions 120 stored in the memory 118, to:
determine an estimated time of arrival (ETA) for the delivery trip;
determine a level of confidence for the ETA;
determine a delivery time threshold based on a delivery distance for the delivery trip;
determine a customer sensitivity factor based on historical transaction data for a user related to the delivery trip; and
determine an ETA buffer time based on the level of confidence, the delivery time threshold and/or the customer sensitivity factor.

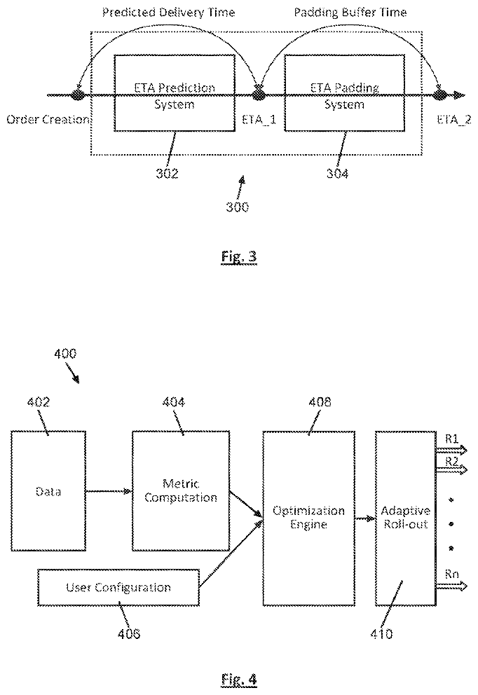

Further, it will be appreciated that FIG. 4 and the foregoing description illustrates and describes a method performed in a communications server apparatus 102, the method comprising, under control of a microprocessor 116 of the server apparatus 102:
determining an ETA for the delivery trip;
determining a level of confidence for the ETA;
determining a delivery time threshold based on a delivery distance for the delivery trip;
determining a customer sensitivity factor based on historical transaction data for a user related to the delivery trip; and
determining an ETA buffer time based on the level of confidence, the delivery time threshold and/or the customer sensitivity factor.

In e-commerce servers with higher numbers of transactions, even a slight improvement in user experience (such as accuracy of ETA estimate) makes a big difference in the everyday life of customers.

For example, the ETA prediction is a key service in the food/grocery delivery industry and its performance affects consumer's experience as it will be shown to the consumer before he/she places the order. Current existing ETA prediction systems usually apply machine learning algorithms/models to predict the delivery time where the main metrics used to evaluate them are the ETA accuracy, lateness and earliness. For a specific allowable prediction error T, these metrics are defined as the percentage of those respective orders:
1. ETA earliness: the ATA is earlier more than T mins, i.e. the order arrives earlier,

$$ETA - ATA > T$$

2. ETA accuracy: the time between ETA and actual time of arrival (ATA) is within the threshold,

$$abs ( ATA - ETA ) <= T$$

3. ETA lateness: the ATA is later more than T mins, i.e. the order arrives later,

$$ATA - ETA > T$$

The ETA prediction will be one of three cases: earlier, accurate or later. The order which is delivered later will heavily affect the consumer's satisfaction as they need to wait a long time for the order to arrive. The order in case 1 and 2 are considered as delivered on-time and the ETA promise is kept therefore and we have ETA promise=ETA accuracy+ETA earliness.

So we can actually reduce ETA lateness by simply providing a larger estimated delivery time and in turn improve the consumer's experience from the perspective of ETA promise. However, a larger delivery time will dampen the demand by making the consumer less likely to place the order since the delivery time is longer than their expectations. Thus to make the ETA prediction more effective, it is not adequate to only consider the above three mentioned metrics in ETA prediction. The conversion rate may be a factor and the consumer's expectation of delivery time may be a factor.

Therefore, a dynamic buffer time may be added into the estimated delivery time which is optimised based on various factors: delivery distance, historical metrics of ETA system, consumer's personalized characteristics and/or as global constraints of delivery time for drivers. This ETA system is to maximize the satisfaction of the consumers while at the same time to not dampen their demands.

Prior art ETA estimation is usually based on machine-learning algorithms. The delivery time is a combination of several components (allocation time, cooking time, pick-up time (driver to collect the order), drop-off time (driver to deliver the order). As shown in FIG. 3, ETA_1 (Order Creation Timestamp+Estimated Delivery Time) is usually the output of current ETA systems 302 which only aims to maximize the accuracy of the prediction (i.e. ETA accuracy).

In our proposed system, apart from the traditional methods, it has an additional ETA padding system 304. This system is to maximize the satisfaction of the consumer by adding an additional buffer time to the ETA estimation system 302. The new ETA is ETA_2 (Order Creation Timestamp+Estimated Delivery Time+Padding Buffer Time).

The proposed ETA padding system 304 is a sustainable system which can optimise and update itself, which combines the exploitation and exploration in the optimisation process.

One advantage of padding buffer time in one or more embodiments is not to improve ETA accuracy (|ATA−ETA|<=T, i.e. actual arrival time value is to be as close as possible to the estimated arrival time, not too early and not too late), but instead to maximise overall consumer experience which is measured by ETA promise (ATA−ETA<=T, i.e. actual arrival time is not much later than estimated arrival time) and conversion rate (consumer doesn't cancel the order due to long ETA).

While ETA accuracy metric is still important to measure prediction model performance (technical metric), in one or more embodiments a consumer experience metric, which considers consumer perception towards given ETA, balances ETA promise reliability with conversion rate of potential orders.

The ETA estimation system 302 in FIG. 3 may be implemented by multiple machine learning algorithms to predict different time components (allocation time, order preparation time, driver picking up time, driver drop off time, driver waiting time etc.). The ETA prediction could be a sum of these time components.

For example, in the food delivery industry, the delivery time will be t=allocation time+max (picking up time+waiting time, food preparation time)+drop off time+batching time. Where allocation time is the time to find a driver, picking up time is the time a driver spends on-road to reach the merchant and waiting time is the time a driver waits for the food to be ready at the restaurant. Drop off time is the time a driver delivers the food to the consumer after collecting the food and batching time is the additional time required for batched orders. For different user cases, the formula may have some difference.

For each component above, it can be predicted by a model trained based on historical data and after the system has the prediction of different time components, the total delivery time can be calculated.

The framework of the proposed ETA padding system 304 from FIG. 3, is shown in FIG. 4. The optimisation system 400 includes:
Data 402: pipelines or modules to collect necessary data/Features from the Application.
Metric Computation 404: calculators to calculate the metrics of the system, like ETA promise, ETA accuracy, conversion rate, confidence score.
User configuration 406: the interface for user to set different objective functions.
Optimisation Engine 408: a module using optimisation algorithm to generate the exploration models in some linear or nonlinear forms and select the optimal model.
Adaptive Roll-out 410: different models with exploration model, optimal model and based model, which will be given a small traffic for testing.

For example, the data collection system 402 may be implemented with a user side app designed to be downloaded and installed on a mobile phone. In that case, data may be collected from the App in relation to the user's behavioural data.

### Metric Computation

The metric computation 404 described below, can be processed and computed on any distributed big data platform such as hadoop, spark etc.

### F1: Historical ETA

Firstly, some metrics can be aggregated from historical data: performance of the current ETA prediction and the statistics of actual time of arrival (ATA) (at a specific level: restaurant X is_weekday X delivery_distance X delivery_hour) for both batched orders and single orders (batch order: multiple orders will be collected and a driver will deliver them simultaneously in a trip; single order: driver will deliver only one order at one time):
ETA_promise: The percentage of orders delivered on-time from the group.
ATA_mean value: the mean value of actual time of arrival for orders within the group.
ATA_stddev: the standard deviation of delivery time for orders within the group.
The “group” here is obtained by splitting the whole orders with the filter restaurant X is_weekday X delivery_distance X delivery_hour for single and batched orders separately. All metrics and distribution are calculated at group-wise level.

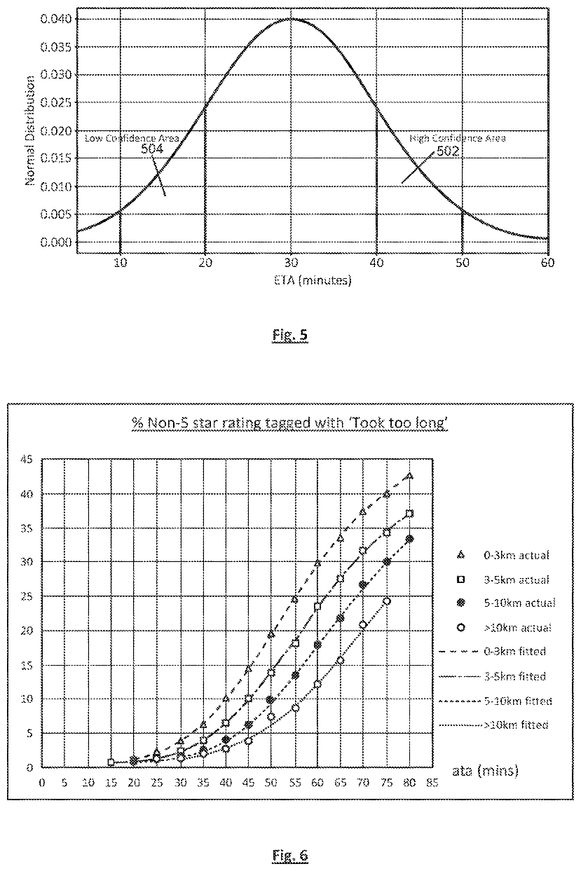

The distribution of ETA for each group, is assumed to be a normal distribution (which is determined by the aggregated ATA_mean (μ) and ATA_stddev (σ) from historical data) as shown in FIG. 5.

$$f ( x ) = \frac{1}{σ \sqrt{2 π}} {ea}^{- {( x - μ )}^{2} / 2 {σ}^{2}}$$

For a prediction, if it falls in the right part 502, we will give it a higher confidence score and in this case it is less likely that we need to add additional buffer time to the ETA, while for the prediction in the left part 504, the confidence score will be lower. If the estimated delivery time is X (calculated using ETA estimation system 302), then we have the cumulative probability:

$$P ( X , μ , σ ) = \frac{1}{\text{?}} a {\int }_{- w}^{X} exp ( - \frac{\text{?}}{\text{?}} ) dt = Φ ( \frac{\text{?}}{\text{?}} )$$

$$\text{?} \text{indicates text missing or illegible when filed}$$

Where

$$Φ ( \frac{X - μ}{σ} )$$

is a cumulative probability function for normal distribution (CPF for Where normal distribution).

As part of our ETA buffer system 304, we have a model using machine learning algorithms to predict whether the order will be a batched order or a single order.

From historical data: we extract some features (historical batching rate, number of batched orders, number of single orders, delivery direction of orders etc), and train a machine learning algorithm to predict the objective: the label of order (batched or single). This training model can then be used to determine the probability of a particular new order being batched.

The predicted probability is bp, where 0<=bp <=1 indicating the probability of an order to be batched.

So, the final confidence score of the ETA prediction is defined as

$$confidence score = bp * Φ ( \frac{\text{?}}{\text{?}} ) * ETA {promise}_{b} + ( 1 - bp ) * Φ ( \frac{\text{?}}{\text{?}} ) * ETA promis \text{?}$$

$$\text{?} \text{indicates text missing or illegible when filed}$$

Where u is the mean of ATA and σ is the standard deviation of ATA and ETA promise is the historical ETA promise kept from historical data. The subscript b and s indicate the metrics are from batched orders or single orders.

Generally speaking, if the confidence score is high, which means that we are highly confident that the current ETA will be kept (the delivery will arrive on time before the ETA+T minutes), so in this case, the padding buffer will be a smaller value. Otherwise, for those orders with low confidence score, a large padding value will be added.

The historical order data is stored in tables in database. The tables will include all timestamps for an order's life cycle (the actual & predicted values of order creation time, allocation time, order ready time, order collection time order completed time).

### F2: Delivery Time Threshold Based on Delivery Distance

To guarantee a good experience for the consumer, we set some certain constraints on the delivery time based on the delivery distance. Those constraints are obtained through the study of historical delivery time and the satisfaction of the consumers. For example: the delivery time for those orders with delivery distance less than D1 should be delivered with a time less than T1, orders with distance between D1 and D2 should be delivered with a time less than T2, and so on and so forth. These values are important factors to evaluate the efficiency of a delivery system and they are also helpful to determine how we calculate the padding buffer time.

TABLE 1
constraints on delivery time for different distance

| Distance | Max Delivery Time |
|---|---|
| 0-D1 | T1 |
| D1-D2 | T2 |
| D2-D3 | T3 |
| D3-D4 | T4 |
| >D4 | T5 |

Generally speaking, if the estimated delivery time is close to the max delivery time, the padding buffer will be a smaller value; otherwise, for those orders with estimated delivery time much less than the max delivery time, a larger padding value will be added. This tries to assure that the final delivery time will not exceed the max delivery time (or not exceed it too much) which exceeds the consumer's expectation.

### Example Method of Determining F2

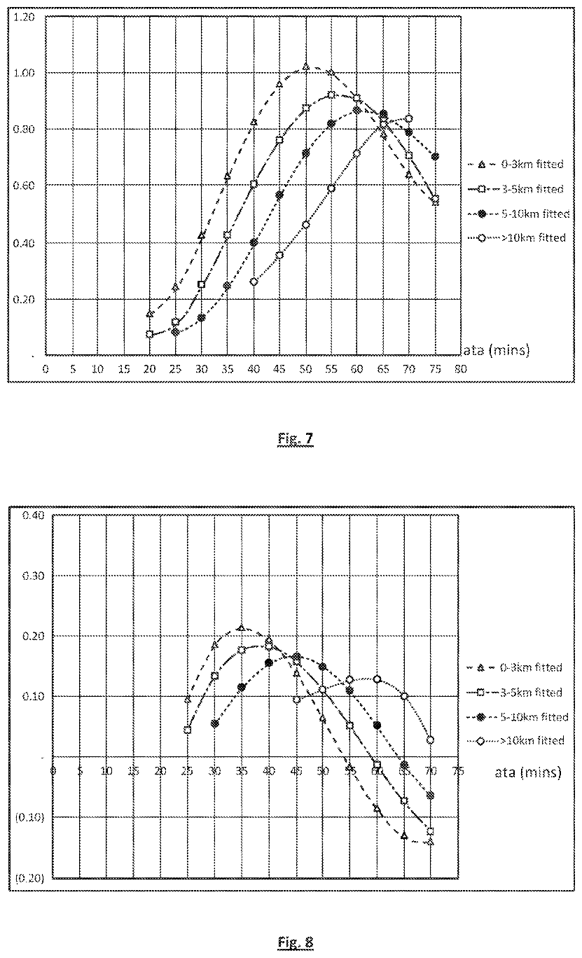

Delivery time threshold F2 is calculated based on historical data of consumer review and actual delivery time (i.e. ATA=actual time of arrival) against delivery distance.
Step 1: Plot percentage of non-5 star consumer review rating that is related to long delivery time against actual delivery time across different bucket of delivery distance (as shown in FIG. 6).
Step 2: Plot (with some fitting) the slope (rate of change) and delta slope of the previous plot (as shown in FIGS. 7 and 8).
Step 3: Delivery time threshold for different bucket of delivery distance is determined based on the inflection point of the delta slope, e.g. for 0-3 km bucket the fitting plot start to change direction at ˜35 mins delivery time.

| Mex to eater distance (km) | 0-3 km | 3-5 km | 5-10 km | >10 km |
|---|---|---|---|---|
| Delivery time threshold (mins) | 35 mins | 40 mins | 45 mins | 60 mins |

F3: Personalized Profile of Consumers

This variable is based on the fact that different consumers will have different expectations of the delivery time. For example: for an order with a delivery distance D1, if the estimated delivery time is ET1, consumer A will place the order while consumer B will not as the delivery time is longer than his/her expectation. Based on their behaviours and feedback (how/whether they place an order or not; their feedback: whether the delivery time is too long?). We can obtain some personalized information as follows:
Statistics of the favourable orders: the median/average time of the delivery time, the min/max value of the delivery time.
Statistics of unfavourable orders: the median/average time of the delivery time, the min/max value of the delivery time.
Consumer feedback (if available): consumer input their expectations of delivery time via survey or other interaction methods.
We can send questionnaires or in-app surveys to get some data.
The cancellation rate and consumer rating data may be used: the consumer will cancel the order or high a low rating on the driver due to reasons like: long delivery time; punctuality reasons etc. these can be aggregated into useful statistics.

Generally speaking, if the consumer is highly sensitive to long delivery times, the padding buffer will be a lower value; otherwise, for those lower sensitivity customers, a larger padding value will be added.

The historical data about the users is stored in a database. The fields include: consumer id, order timestamp, the delivery time, predicted delivery time rating, order status (whether it is completed or cancelled), rating, comments etc.

The orders can be grouped into favourable orders or unfavourable ones based on their rating and feedback. Selecting a threshold t1 and t2 based on expertise, favourable ones: orders with rating >t1 and orders with explicit feedbacks that are delivered on time; unfavourable ones: orders with rating <t2 and orders with explicit feedbacks that are delivered on time. For the two groups, we can calculate their mean and median, min/max values respectively. (denote as mean_f, median_f, min_f, max_f, mean_u, median_u, min_u, max_u)

Consumer input from the app or questionnaires can be the expected delivery time, which can be a numeric value. (t_expected)

Cancellation rate for orders with different estimated delivery time can be, for example: cancellation rate for orders with ETA <10 mins: R10; cancellation rate for orders with 10 mins<ETA <20mins R10_20; cancellation rate for orders with ETA 20 mins<ETA<30 mins R20_30; cancellation rate for orders with ETA>30 mins: R30;

The format the personal information finally is a vector including all the above values V=[mean_f, median_f, min_f, . . . , t_expectd, . . . R10 , . . . , R30 ].

### F4: Real Time Signal

The real time signal can be some signals indicating the driver supply demand ratio, such as the number of ongoing orders, the number of drivers nearby, and number of allocating (is still finding a driver) & allocated (already found a driver) orders. Furthermore, the real-time promotion information can be the inputs as the consumer might have different expectations of delivery time if promotion is provided. These real-time signals can be aggregated via Apache Flink® framework based on the real-time streaming data collected from product users. For example, an Apache Flink® platform may be used to provide real-time data streaming from app users as one of input feature to the prediction model.

Generally speaking, if the supply demand ratio is very low, the padding buffer will be a larger value; otherwise, or if a promotion encouraging faster delivery is provided, a lower padding value will be added if promotion is provided at the merchant side, order will be cheaper and consumers can tolerate a longer delivery time, padding value can be larger.

The signals listed are calculated using Flink based on the real-time data with some aggregation actions:

driver supply ratio = num of allocated orders/total ongoing orders;
num of orders ongoing = count(orders created but not completed);
num of orders allocated = count(orders created and allocated); and
num of orders allocating = count(orders created but not allocated).

The output is a vector of these numeric values: [driver supply demand ratio, number of orders ongoing, . . . , is_promotion_provided]

### User Configuration

The user must provide configuration of the objective functions, so the optimisation engine can generate the models accordingly. This configuration may be provided via a web-based user interface 406 or document which allows the user to input different parameters.

The data we used include historical delivery time, consumer's behavioural data and their feedback. User configuration part allows user to input the objective for the optimisation, for example:

$$f ( objective ) = α * ETA Promise + β * conver \text{?} ion rate$$

$$\text{?} \text{indicates text missing or illegible when filed}$$

User can specify α and β to make a trade-off between ETA promise and conversion rate. The objective function can also include other metrics if necessary. Different objectives can be set for different groups (different cities/countries).

The two parameters α and β are the weights for eta_promise and conversion_rate in the objective function (α+β=1 to make sure the weight sum is one). Generally speaking, for example, is α=0.5 and β=0.5, the system will have a solution which considers its impact of eta-promise and conversion rate equally. If a user sets a higher weight for eta_promise and a lower weight for conversion rate (for example α=0.8 and β=0.2), the system will mainly focus on improving the eta_promise with some sacrifice on conversion rate comparing with the balanced case (α=0.5 and β=0.5). If the user wants to have a higher conversion rate instead, the weight for conversion rate can be set as a higher value.

These parameters can be set by the user configuration 406 via web UI or a parameter document. After getting the parameters, the system will automatically get the optimal solutions by the Optimisation Engine.

### Optimisation Engine

The Optimisation Engine 408 described below may be implemented on a cloud computing platform.

The optimisation engine will optimise the padding value which will maximize the objective function f(objective), where padding buffer time (bt) can be in a linear form, i.e. a weighted summation of all inputs:

$$bt = {w}_{1} \text{?} confidence score + \text{?} delivery time threshold + \text{?} personalized profile + \text{?} real time signal$$

$$\text{?} \text{indicates text missing or illegible when filed}$$

These weighting parameters are optimised by the optimisation engine which will maximise the objective function via different optimisation algorithms.

Or in a non-linear form:

$$\text{?} = \text{?} ( confidence score , delivery time threshold , personalized profile , real time signal , … )$$

$$\text{?} \text{indicates text missing or illegible when filed}$$

Where f(.) can be any nonlinear functions or any complex machine learning models. The parameters in the linear form or the model in the nonlinear form can be found by the optimisation solver, for example: Bayesian Optimiser in Python Scikit or Radial Basis Function method in RBFOP, etc. f(.) can be a machine learning model, for example the tree-based models (gradient based decision tree (GBDT) or random forest model), or Neural networks

The user will login to the system using their predefined login credentials and create a proposed order online or on a mobile phone app. The system will ultimately inform the user of the ETA_2 (Order Creation Timestamp+ETA+bt). The user will then decide whether to proceed with the order or delivery based at least partially on their perception of the ETA_2.

### Adaptive Roll-Out

In this system, users can have multiple configurations and the optimisation can have multiple outputs as well. For example, the roll-out can have n outputs: (one is the base model, one is the optimal ones and the rest will be some exploration models from the optimisation engine through exploitation & exploration).
Base model: some base models based on some single rules (for example: a fix value of bt=0 minutes or bt=2 minutes).
Exploitation model: the optimal models which are found during the optimisation history based on the objective function.
Exploration model: To overcome the optimisation engine stuck in some sub- optimal zone, some exploration models will be roll-out (for example: random search of some parameters which generate some new models based on the collected data).

After the multiple models have been generated by the Optimisation Engine and rolled out in production, new data can be collected from the new models and new metrics are available for the system to re-optimise and self-update itself.

And these models will also be given a small part of the traffic and the system can collect those data for optimal model selection and new exploration model optimisation in the next iteration.

The experiment can be set as a daily (hourly, weekly or monthly can be the choice) job in which the system will execute the steps every day to re-optimise and update the models.

An example is as follows:
Initialize the optimisation engine from user configuration and a base model user configurations are the input of parameters for eta_promise and conversion rate parameters. A base model is the control group which initialized by the system (bt=0 or bt=2 mins for all orders).
While experiment is ongoing do
   Collect historical data; historical data will include the information of consumer's view/order history: including these main columns: (consumer page view history, consumer order history, ATA & ETA, consumer rating & feedbacks, consumer comments etc.) And based on these data, we can calculate the features accordingly (F1, F2, F3, F4), which are the input of the optimisation engine.
   Calculate different metrics from the historical data; The main metric the system will calculate is the eta_promise and conversion rate.
   Generate N exploration models from historical data which maximizes the objective function. Once we have the input feature (F1, F2,F3,F4) and the objective function (

$$f ( objective ) = α * ETA Promise + β * conversion rate .$$

), the optimisation solver will automatically generate some models.
Select optimal models from historical models based on latest metrics observed; The system can self-update & optimise itself by iteration. For example: in current iteration t, we will generate N models (denoted as t-1, t-2, . . . t-N), note that we have N models in previous iteration t_1 as well (denoted as t_1-1, t_1-2, . . . t_1-N). for the N models in the t-1 iteration, we have run it for some time and have some data. The metric eta_promise and conversion rate can be calculated. The optimal model is the one which have maximised the objective function

$$f ( objective ) = α * ETA Promise + β * conversion rate ) ,$$

So, for iteration t, we will roll out these models: base model; exploration model: t-1,t-2,t-3, . . . t-N, and exploitation model optimal one selected from t_1-1, t_1-2, . . . t_1-N.
   Roll out the different models with proper traffics;
   optimal model will have the largest traffic and a small percentage of traffic for base model and exploration model [for example, exploitation model: (90%), and 5% for base model and 5% for exploration models)]. After these models are rolled out, we can collect the data and update the models iteratively.
end

As will be appreciated by a person skilled in the art, a range of factors may be used in the optimisation according to the requirements of the application. In at least the use applications mentioned above, there are one or more technical solutions provided including taking into account the users sensitivity to longer delivery times in determining an ETA estimate buffer time to add to an ETA estimate.

It will be appreciated that the invention has been described by way of example only. Various modifications may be made to the techniques described herein without departing from the spirit and scope of the appended claims. The disclosed techniques comprise techniques which may be provided in a stand-alone manner, or in combination with one another. Therefore, features described with respect to one technique may also be presented in combination with another technique.

1. A communications server apparatus for estimated time of arrival (ETA) estimation for a delivery trip, the communications server comprising a processor and a memory, the communications server apparatus being configured, under control of the processor, to execute instructions stored in the memory, to:
determine an ETA for the delivery trip;
determine a level of confidence for the ETA;
determine a delivery time threshold based on a delivery distance for the delivery trip;
determine a customer sensitivity factor based on historical transaction data for a user related to the delivery trip; and
determine an ETA buffer time based on at least one of (i) the level of confidence, (ii) the delivery time threshold and (iii) the customer sensitivity factor.

2. The server apparatus of claim 1 wherein the level of confidence is based on a comparison to historical delivery trip data.

3. The server apparatus of claim 2 wherein the historical delivery trip data includes separate single trip delivery data and batched trip delivery data, and the determining the level of confidence includes determining a probability that the delivery trip will be a batched trip compared to the probability that the delivery trip will be a single trip.

4. The server apparatus of claim 1 wherein the customer sensitivity factor is based on any patterns in relation to that user's behaviour in respect of previous orders and published ETAs for those corresponding previous orders.

5. The server apparatus of claim 4 wherein the behaviour includes analysing the user's historical proposed orders, in particular analysing instances where the user declined the order after being informed of the ETA.

6. The server apparatus of claim 1 wherein the communications server apparatus is further configured to optimise a model for determining an ETA buffer time.

7. The server apparatus of claim 6 wherein the communications server apparatus is further configured to optimise the model based on maximising an objective function.

8. The server apparatus of claim 7 wherein the communications server apparatus is further configured to optimise further models for determining an ETA buffer time based on at least one of: (i) an Exploitation model and (ii) an Exploration model.

9. The server apparatus of claim 8 wherein the communications server apparatus is further configured to test the further models using a small number of delivery trips, and if they prove successful, replacing the model with one of the further models.

10. A method performed in a communications server apparatus for data aggregation, the method comprising, under control of a processor of the communications server apparatus, comprising:
determining an estimated time of arrival (ETA) for the delivery trip;
determining a level of confidence for the ETA;
determining a delivery time threshold based on a delivery distance for the delivery trip;
determining a customer sensitivity factor based on historical transaction data for a user related to the delivery trip; and
determining an ETA buffer time based on at least one of (i) the level of confidence, (ii) the delivery time threshold and (iii) the customer sensitivity factor.

11. A computer program or computer program product comprising instructions for implementing the method of claim 10.

12. A non-transitory storage medium, storing instructions, which when executed by a processor, causes the processor to perform the method of claim 10.

13. A user communications device for communicating with an e-commerce server comprising a processor and a memory, the communications device being configured, under control of the processor, to execute instructions stored in the memory to:
request the e-commerce server to provide an estimated delivery time (ETA) for a proposed transaction;
receive the ETA, including an ETA buffer time based on any patterns in historical proposed orders that the user had rejected; and
send a payment authorisation request for the transaction if the user accepts the ETA.

14. An e-commerce server payment system, comprising:
a communications server;
at least one driver communications device;
at least one user communications device; and
a communications network equipment configured for the communications server, the at least one driver communications device, and the at least one user communications device, to establish communication with each other therethrough;
wherein the driver communications device comprises a first processor and a first memory, the driver communications device being configured, under control of the first processor, to execute first instructions stored in the first memory to:
send data regarding the driver's location;
and wherein the communications server comprises a second processor and a second memory, the communications server being configured, under control of the second processor. to execute second instructions stored in the second memory to:
receive a proposed new transaction,
estimate an estimated time of arrival (ETA) for the proposed new transaction, including an ETA buffer time based on any patterns in historical proposed orders that the user had rejected, and
if the user accepts the estimated ETA, receive a payment authorisation request for the transaction; and
wherein the user communications device comprises a third processor and a third memory; the user communications device being configured, under control of the third processor, to execute third instructions stored in the third memory to:
receive a payment authorisation if the transaction has been approved.

15. A method, performed in an e-commerce server, the method comprising, under control of processors for one or more server instances:
receiving a proposed new transaction;
estimating an estimated time of arrival (ETA) for the proposed new transaction, including an ETA buffer time based on any patterns in historical proposed orders that the user had rejected; and
receiving a payment authorisation request for the transaction if the user accepts the estimated ETA.

16. A computer program or computer program product comprising instructions for implementing the method of claim 15.

17. A non-transitory storage medium storing instructions, which when executed by a processor, causes the processor to perform the method of claim 15.
